(19) United States
(12) Patent Application Publication
(10) Pub. No.: US 2025/0101942 A1
(43) Pub. Date: Mar. 27, 2025

(54) HYDROELECTRIC POWER GENERATION INCLUDING ARTIFICIAL WATERWAY

(71) Applicant: Robert W. Johner, Ogema (CA)

(72) Inventor: Robert W. Johner, Ogema (CA)

(21) Appl. No.: 18/882,234

(22) Filed: Sep. 11, 2024

Related U.S. Application Data
(60) Provisional application No. 63/584,590, filed on Sep. 22, 2023.

(51) Int. Cl. F03B 17/06

(52) U.S. Cl. CPC F03B 17/06; F05B 2230/50

(57) ABSTRACT

A hydroelectric power generation system includes a closed pipe forming an artificial waterway arranged in the ground under a body of water between an intake and an outlet downstream along the body at a lower height. The artificial waterway comprises lengths of piping which are circumferentially closed; A plurality of generating stations are located along the artificial waterway uniformly spaced apart and each includes a low-speed turbine, a generator, a building which is arranged to be fluidically communicated with the atmosphere where the generating stations are arranged to be electrically connected to a power system grid. Release conduits each associated with a respective generating station are connected between the pipe and the waterway. Some water can be released from the pipe for irrigation.

This application claims the benefit under 35 USC 119 (e) of Provisional application 63/584,590 filed Sep. 22, 2023.

### SUMMARY OF THE INVENTION

According to a first aspect of the invention there is provided a hydroelectric power generation system for a generally-flat downwardly-sloped geographic area having a body of water, comprising:
a system intake arranged at a first elevation and in fluidic communication with the body of water for drawing or receiving water therefrom;
a system outlet arranged at a second elevation lower than the first elevation and in fluidic communication with the body of water for releasing drawn water thereto;
wherein a flow of water is defined in a direction from the system intake to the system outlet;
an artificial waterway arranged in the ground under the body of water and fluidically interconnecting the system intake and outlet, wherein the artificial waterway extends along a linear path oriented at a prescribed downward slope relative to a horizon, wherein the artificial waterway comprises lengths of piping which are circumferentially closed;
a plurality of generating stations disposed at spaced locations along the artificial waterway, wherein the generating stations are uniformly spaced apart from each other such that a distance along the linear path of the artificial waterway between an adjacent pair of the generating stations is substantially equal to a prescribed distance of the artificial waterway between the system intake and an upstream-most one of the generating stations; and
wherein each of the generating stations includes:
   a low-speed turbine arranged along the flow of the water for receiving the water released from an adjacent upstream one of the lengths of piping and configured to rotate in response thereto;
   a generator operatively coupled to the turbine and configured to convert mechanical power from rotation thereof into electrical power;
   a building forming an interior space for receiving the turbine and the generator, wherein the building is arranged to be fluidically communicated with the atmosphere such that the artificial waterway is depressurized at the generating station to atmospheric pressure;
wherein the generating stations are arranged to be electrically connected to a power system grid.

Preferably the system further includes a plurality of emergency water discharge conduits respectively associated with the generating stations, wherein the emergency water discharge conduits are fluidically communicated with the artificial waterway and arranged in fluidic communication with the body of water, and wherein each of the emergency water discharge conduits associated with a corresponding one of the generating stations is fluidically communicated with the artificial waterway at an upstream location from the corresponding generating station relative to the flow of water.

Preferably the system further includes a plurality of irrigation takeoffs in the form of conduits selectively fluidically communicated with the artificial water at selected ones of the lengths of piping for releasing water from the artificial waterway and into an irrigation system.

Preferably the turbines are Pelton wheels.

According to a second aspect of the invention there is provided a method of generating hydroelectricity in a generally-flat downwardly-sloped geographic area having a body of water, comprising:
filling an artificial subterranean waterway formed by closed piping with water drawn from the body of water, wherein the artificial subterranean waterway extends along a linear path oriented at a prescribed downward slope relative to a horizon;
when the artificial subterranean waterway is full of water, guiding the water therein through a plurality of turbines disposed at spaced locations along the artificial subterranean waterway;
depressurizing the artificial subterranean waterway to atmospheric pressure when the water is guided through each of the turbines;
transferring mechanical power output from the turbines to electric generators to convert the mechanical power to electrical power; and
transmitting the electrical power to a power system grid.

Preferably the method further includes discharging water from the artificial waterway upstream from one or more of the turbines to reduce hydraulic pressure in the artificial waterway.

Preferably the method further includes selectively releasing water at intermediate takeoff locations along the artificial waterway to be guided to an irrigation system.

### BRIEF DESCRIPTION OF THE DRAWINGS

FIG. 1 is a schematic diagram of an arrangement of hydroelectric power generation system according to the present invention.

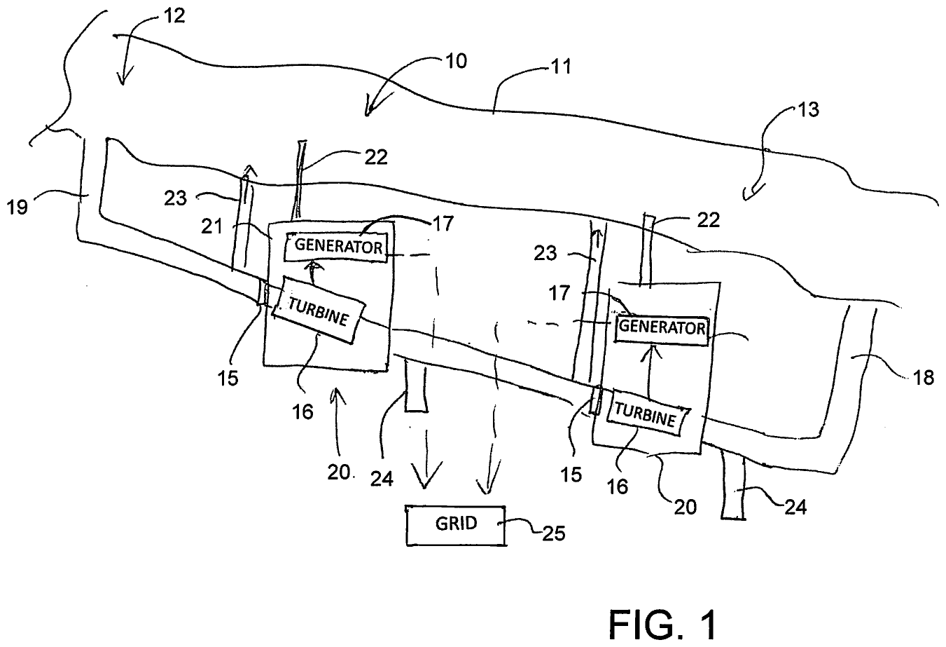

### DETAILED DESCRIPTION

In the accompanying FIGURE (schematic diagram) there is shown an arrangement of hydroelectric power generation system according to the present invention.

The hydroelectric power generation system 10 is arranged in a geographic area which is generally flat, meaning it is not mountainous and has prairies, and which is downwardly-sloped such that a body of water or river 11 within the geographic area flows from higher elevation 12 to lower elevation 13.

Preferably, the body of water is a freshwater body such that in the event of any spills or leaks in the system there is substantially no chemical threat or danger to the surrounding environment.

In one arrangement, the slope of the artificial waterway is 10 feet down for every mile of horizontal distance. This is an example of a prescribed slope, but generally speaking, the prescribed slope is based on, and preferably substantially follows or is commensurate to, a slope of a bed of the body of water between an intake of the system to an outlet or discharge of the system. The slope of the water body bed on which the prescribed slope of the waterway is based may be an average slope value of the water body bed between the system intake and outlet. The pipe feeds a series of turbines 16 ach providing drive to a respective generator 17.

In one arrangement, the distance from the system intake to a release location within the waterway associated with the upstream-most turbine, and then a distance D between each adjacent pair of turbines, is about 30 miles. This is an example of a prescribed distance between the system intake and the upstream-most turbine, and then between adjacent pairs of turbines, but generally speaking, this prescribed distance is based on the slope of the waterway and a prescribed head pressure for operation of the turbines, which is dependent on a type of the turbines used.

In one arrangement, the artificial waterway has a plurality of parallel ducts 15 or pipes 14 respectively feeding a distinct series of turbines 16 to generate more electrical power by parallel turbines with corresponding generators. The pipe is closed around its periphery to fully enclose and contain the water therein.

The water in the artificial waterway or pipe 14 fills a full cross section of the pipe 14 and full length thereof to provide threshold hydraulic pressure for driving 20 the turbines 16, which are of the high-pressure, low-speed type.

Control gates 15 are provided between fluidic elements of the system when it is desired to control the flow of water, including at the generating stations and irrigation takeoffs. Such gates 15 can be provided at the entry to each turbine.

Typically, the system is charged prior to operation or use for outputting electrical power. Charging comprises filling an entirety of the waterway with water such that each generating station has a prescribed threshold head pressure for operation to generate electricity thereat. Filling the waterway or pipe 14 may be achieved by admitting water therein, by opening the system inlet and maintaining, in open positions, control gates 15 on inlet sides of the generating stations, so that water is permitted to pass therethrough to downstream generating stations, all the while maintaining the system outlet closed so that the admitted water is not released from the system but instead accumulates until the waterway is volumetrically full of water so as to contain a maximum water therein, that is in the closed piping.

At each generating station, the water output therefrom is equal to the water input thereto such that no water is lost at any generating station.

The turbines 16 used in the system are of a low-speed high-pressure type meaning maximum rotational speeds of the turbines are generally about half of flow or jet velocity of water on input sides of the turbines

The system outlet 18 is arranged at the second elevation 13 lower than the first elevation and in fluidic communication with the body of water for releasing drawn water thereto.

The artificial waterway or pipe 14 arranged in the ground under the body of water and fluidically interconnecting the system intake 19 and outlet 18, wherein the artificial waterway extends along a linear path oriented at a prescribed downward slope relative to a horizon. The pipe 14 thus forms an artificial waterway defined by lengths 14A of piping which are circumferentially closed.

The plurality of generating stations 20 are disposed at spaced locations along the artificial waterway, where the generating stations 20 are uniformly spaced apart from each other such that a distance along the linear path of the artificial waterway between an adjacent pair of the generating stations is substantially equal to a prescribed distance of the artificial waterway between the system intake and an upstream-most one of the generating stations.

Each of the generating stations 20 includes:
a low-speed turbine 16 such as a turbine of the type known as Pelton wheels arranged along the flow of the water for receiving the water released from an adjacent upstream one of the lengths of piping and configured to rotate in response thereto;
a generator 17 operatively coupled to the turbine and configured to convert mechanical power from rotation thereof into electrical power;
a building 21 forming an interior space for receiving the turbine 16 and the generator 17, where the building is arranged to be fluidically communicated with the atmosphere by a vent 22 such that the artificial waterway is depressurized at the generating station to atmospheric pressure;
where the generating stations are arranged to be electrically connected to a power system grid 25.

The system further includes a plurality of emergency water discharge conduits 23 connected to the pipe 14 each respectively associated with the generating stations 20. The emergency water discharge conduits 23 are fluidically communicated with the artificial waterway and arranged in fluidic communication with the body of water and each of the emergency water discharge conduits is associated with a corresponding one of the generating stations so as to be fluidically communicated with the artificial waterway at an upstream location from the corresponding generating station relative to the flow of water. This can act as an emergency discharge if required or as a supplementary intake of water to fill the pipe 14 if discharge from the pipe occurs such as for irrigation. For example it can be used for discharging water from the artificial waterway upstream from one or more of the turbines to reduce hydraulic pressure in the artificial waterway if required.

The system can further include a plurality of irrigation takeoffs 24 in the form of conduits selectively fluidically communicated with the artificial water at selected ones of the lengths of piping 14 for releasing water from the artificial waterway and into an irrigation system.

The use of a Pelton wheel or Pelton Turbine provides an effective type of turbine for this end use in that the Pelton system is an impulse-type which extracts energy from the impulse of moving water, as opposed to water's dead weight like the traditional overshot water wheel. Many earlier variations of impulse turbines existed, but they were less efficient than Pelton's design. Water leaving those wheels typically still had high speed, carrying away much of the dynamic energy brought to the wheels. Pelton's paddle geometry is designed so that when the rim ran at half the speed of the water jet, the water left the wheel with very little speed; thus his design extracted almost all of the water's impulse energy, which make for a very efficient turbine.

The scope of the claims should not be limited by the preferred embodiments set forth in the examples but should be given the broadest interpretation consistent with the specification as a whole.

1. A hydroelectric power generation system for a generally-flat downwardly-sloped geographic area having a body of water, comprising:
a system intake arranged at a first elevation and in fluidic communication with the body of water for drawing or receiving water therefrom;
a system outlet arranged at a second elevation lower than the first elevation and in fluidic communication with the body of water for releasing drawn water thereto;
wherein a flow of water is defined in a direction from the system intake to the system outlet;
an artificial waterway arranged in the ground under the body of water and fluidically interconnecting the system intake and outlet, wherein the artificial waterway extends along a linear path oriented at a prescribed downward slope relative to a horizon, wherein the artificial waterway comprises lengths of piping which are circumferentially closed;
a plurality of generating stations disposed at spaced locations along the artificial waterway, wherein the generating stations are uniformly spaced apart from each other such that a distance along the linear path of the artificial waterway between an adjacent pair of the generating stations is substantially equal to a prescribed distance of the artificial waterway between the system intake and an upstream-most one of the generating stations; and
wherein each of the generating stations includes:
a low-speed turbine arranged along the flow of the water for receiving the water released from an adjacent upstream one of the lengths of piping and configured to rotate in response thereto;
a generator operatively coupled to the turbine and configured to convert mechanical power from rotation thereof into electrical power;
a building forming an interior space for receiving the turbine and the generator, wherein the building is arranged to be fluidically communicated with the atmosphere such that the artificial waterway is depressurized at the generating station to atmospheric pressure;
wherein the generating stations are arranged to be electrically connected to a power system grid.

2. The hydroelectric power generation system of claim 1 further including a plurality of emergency water discharge conduits respectively associated with the generating stations, wherein the emergency water discharge conduits are fluidically communicated with the artificial waterway and arranged in fluidic communication with the body of water, and wherein each of the emergency water discharge conduits associated with a corresponding one of the generating stations is fluidically communicated with the artificial waterway at an upstream location from the corresponding generating station relative to the flow of water.

3. The hydroelectric power generation system of claim 1 further including a plurality of irrigation takeoffs in the form of conduits selectively fluidically communicated with the artificial water at selected ones of the lengths of piping for releasing water from the artificial waterway and into an irrigation system.

4. The hydroelectric power generation system of claim 1 wherein the turbines are Pelton wheels.

5. A method of generating hydroelectricity in a generally-flat downwardly-sloped geographic area having a body of water, comprising:
filling an artificial subterranean waterway formed by closed piping with water drawn from the body of water, wherein the artificial subterranean waterway extends along a linear path oriented at a prescribed downward slope relative to a horizon;
when the artificial subterranean waterway is full of water, guiding the water therein through a plurality of turbines disposed at spaced locations along the artificial subterranean waterway;
depressurizing the artificial subterranean waterway to atmospheric pressure when the water is guided through each of the turbines;
transferring mechanical power output from the turbines to electric generators to convert the mechanical power to electrical power; and
transmitting the electrical power to a power system grid.

6. The method of claim 5 further including discharging water from the artificial waterway upstream from one or more of the turbines to reduce hydraulic pressure in the artificial waterway.

7. The method of claim 5 further including selectively releasing water at intermediate takeoff locations along the artificial waterway to be guided to an irrigation system.
